(19) United States
(12) Patent Application Publication
(10) Pub. No.: US 2009/0048386 A1
(43) Pub. Date: Feb. 19, 2009

(54) METHOD FOR TREATMENT OF CARBON NANOTUBES

(75) Inventor: Dominique Plee, Lons (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 11/816,182

(22) PCT Filed: Feb. 10, 2006
(86) PCT No.: PCT/FR2006/000308

§ 371 Date: Aug. 26, 2008

Related U.S. Application Data
(60) Provisional application No. 60/729,794, filed on Oct. 24, 2005.

(30) Foreign Application Priority Data
Feb. 17, 2005 (FR) 0501623

(51) Int. Cl. C08K 3/04; D01F 9/12; B82B 1/00; B82B 3/00

(52) U.S. Cl. 524/496; 423/447.1; 423/447.2; 977/847; 977/745

(57) ABSTRACT

The invention relates to a simple and economic method for treatment of carbon nanotubes, in particular, for the modification of the surface thereof by functionalisation for improving the compatibility thereof with polar media, such as, certain polymers, resins or solvents. The invention further relates to nanotubes treated thus and the use thereof in the electronic, electro-mechanical and mechanical fields in which the above represent an advantageous replacement for untreated carbon nanotubes.

### TECHNICAL FIELD

The invention relates to carbon nanotubes (CNTs) and to a treatment method, in particular for modifying their surface by functionalization, so as to increase, for example, their compatibility with polar media, such as certain polymers, resins and/or solvents.

### PRIOR ART

Carbon nanotubes are recognized at the present time as being materials having great advantages because of their mechanical properties, their very high aspect (length/diameter) ratios and their electrical properties.

They are made up from graphite sheets that are wound up and terminated by hemispheres consisting of pentagons and hexagons with a structure similar to fullerenes.

Nanotubes are known to be composed of either a single sheet—referred to as single-walled nanotubes (or SWNTs)—or several concentric sheets called multi-walled nanotubes (or MWNTs). In general, SWNTs are more difficult to manufacture than MWNTs.

Carbon nanotubes may be produced by various processes, such as electrical discharge, laser ablation or chemical vapour deposition (CVD).

In this method, a carbon source is injected at a relatively high temperature onto a catalyst, the said catalyst possibly consisting of a metal supported on an inorganic solid. Among metals, iron, cobalt, nickel and molybdenum are preferably used, while among supports, alumina, silica and magnesia are often found.

The carbon sources that may be envisaged are methane, ethane, ethylene, acetylene, ethanol, methanol, acetone or even CO+H₂ synthesis gas (the HIPCO process).

Among the documents presenting the synthesis of carbon nanotubes, mention may be made of WO 86/03455 A1 from Hyperion Catalysis International Inc. corresponding to EP 225 556 B1, which may be considered as one of the basic patents regarding the synthesis of CNTs, which claims carbon fibrils (the old name for CNTs) that are almost cylindrical, the diameter of which is between 3.5 and 70 nm, the aspect ratio being equal to 100 or higher, and also the method of preparing them.

Among these techniques, CVD seems at the present time to be the only one capable of being able to manufacture CNTs in large quantity, an essential condition for having a manufacturing cost allowing them to be used in bulk in polymer and resin applications. However, it has been found that the structure of the CNTs formed by CVD is often highly entangled and this phenomenon is accentuated all the more when the mass productivity is increased, on the one hand, to improve production and, on the other hand, to reduce the residual ash content. It has been found that the greater entanglement of the CNTs goes hand in hand with reduced dispersability in polymeric matrices, such as matrices based on polyamides, polycarbonates, polyesters, styrene polymers, polyetheretherketones (PEEK) and polyetherimides (PEI).

Since the degree of dispersion substantially affects the properties of the polymer/CNT composites, various techniques have been employed to improve it.

There is therefore a need to improve the dispersability properties of CNTs in polymer matrices, while still taking care to preserve as far as possible the properties of carbon nanotubes, especially their mechanical and electrical properties. Among existing technical solutions, mention may be made of:
sonification or ultrasonic treatment, but the effect of this rapidly ceases once the source of ultrasound is turned off, it often being observed that the CNTs reagglomerate;
modification of the surface of the CNTs by surfactants, but this has the drawback of introducing impurities in so far as the said surfactants remain on the surface of the CNTs. In particular, this approach has been adopted in the case of sodium dodecylsulphate (SDS). The nanotubes thus treated form stable suspensions in water, but these assemblies are unstable and a post-dialysis, purported to remove the excess surfactant, detaches all of the SDS in a few hours; and
functionalization of the ends or side walls of the CNTs.

The literature cites many methods for modifying the surface of nanotubes using this functionalization technique. Two main methods are employed:
1) direct attachment of functional groups to the wall;
2) formation of carboxylic acids and chemical reaction.

The grafting of fluorine is mentioned by Kelly et al. (Chem. Phys. Lett. 313, (1999), 445-450) and Michelson et al. (Chem. Phys. Lett. 296, (1998), 188-194). In these studies, the SWNT-type nanotubes are subjected to a stream of gaseous fluorine at temperatures ranging from 150° C. to 600° C. For temperatures above 400° C., the structures are destroyed. Nevertheless, F/C atomic ratios of up to 0.5 are achieved while still maintaining the nature of the nanotube. At these ratios, the sp² character and, consequently, the conducting properties of the CNTs are lost. Michelson also shows that chemical defunctionalization of the fluorine is possible, allowing the electrical conductivity to be restored.

Pekker et al. (J. of Phys. Chem. B, (2001), 105, 7938-7943) hydrogenate nanotubes in liquid ammonia, but here again the conducting character is lost, by loss of aromaticity.

Haddon et al. show that it is possible to use carboxylic acid functional groups to attach alkyl groups, either by amidation reactions or by ammonium-carboxylate-type interactions (Science, (1998), 282, pp 95-98 and J. Phys. Chem. B, (2001), 105, pp 2525-2528.

Sun et al. conclude, for their part, that esterification can be applied to the functionalization and to the solubilization of nanotubes of any length (Chem. Mater., (2001), 13, pp 2864-2869). These same authors observe that the reverse operation, namely defunctionalization is possible (Nano Lett., (2001), pp 439-441).

Quin et al. (Macromolecules, (2004), 37, pp 752-757) graft butyl methacrylate or polystyrene onto the walls and the ends of the nanotubes by controlled radical polymerization.

The latter methods are quite complex and require a reaction step intended to attach an oligomer or a polymeric part to the nanotube.

US 2002/0100578 A1, in the name of J. M. Teplitz, discloses a heat-transfer fluid based on carbon nanotubes dispersed in ethylene glycol. The nanotubes are firstly treated with a sodium hypochlorite solution and then acidified, the surface OH groups being grafted by 2-chloroethanol so as to promote the dispersion of the nanotubes in the solvent.

U.S. Pat. No. 6,203,814 B1, in the name of Hyperion Catalysis, discloses a method in which the nanotubes are oxidized by treating them in the presence of a chlorate in a strong acid medium, followed by reaction with a functional group, such that the final formula is: CₙHᵢ(Aₘ), where n is an integer, i is less than 0.1n, and m is less than 0.5 (C, H and A respectively representing carbon, hydrogen and a functional group chosen from OY, NHY, C(O) OY, C(O)NR′Y, C(O)SY, C(R′), where Y is selected from the following functional groups: alcohols, amines, thiols, acid chlorides, urethanes, etc.

WO 01/94260 discloses the synthesis of SWNT-type CNTs on a supported catalyst and provides a treatment with a strong acid in order to purify the CNTs and to separate them from the support. In EP 1 399 384 B1 in the name of INPT, MWNT-type CNTs are prepared, which are then purified by dissolving them in acid according to the teaching of the previous reference; in the examples, the treatment is carried out using sulphuric acid.

### SUMMARY OF THE INVENTION

The subject of the invention is a simple method of treating carbon nanotubes by means of sodium hypochlorite, which method produces a large quantity of oxygen-containing functional groups on the surface, a reduced ash content and good dispersion of the CNTs in polar media. The method according to the invention is suitable for any type of CNT, whether MWNT or SWNT, prepared using any type of synthesis. Compared with the known technical solutions, the method according to the invention produces a larger quantity of oxygen-containing functional groups.

Compared with the known techniques, the treatment method according to the invention has the advantage of being carried out under mild conditions, both in terms of temperature and pH, contrary to the treatments using nitric acid or sulphuric acid which, in addition to their hazardous nature, generate considerable aqueous acid waste that then has to be treated. Treatments at room temperature with nitric acid or sulphuric acid are also, in practice, ineffective for reducing the ash content of the carbon nanotubes and for creating oxygen-containing surface functional groups.

The Applicant has also found that treatment with hydrogen peroxide does not create as many oxygen-containing surface functional groups as the sodium hypochlorite treatment according to the invention that will be explained in detail below.

According to the invention, the method of treating the CNTs consists in:
treating the carbon nanotubes with a preferably aqueous sodium hypochlorite solution having NaOCl concentrations of between 0.5% and 15% by weight, preferably between 1% and 10%, at temperatures not exceeding 60° C. for a time varying from a few minutes up to 24 hours;
optionally, after this treatment, acidifying the medium to a pH<5 by means of a mineral or organic acid, preferably in the case in which the sodium hypochlorite concentration of the medium exceeds 3 to 4%;
separating the CNTs thus treated, for example by filtration, and then washing them, for example by means of water; and
drying them.

A variant of the method consists in preserving the carbon nanotubes without drying them after washing. This variant is particularly advantageous if it is desired to offer carbon nanotubes dispersed in a water-miscible solvent added after washing with water. Thus, any handling of nanotube powder and the possibility of the CNTs reagglomerating during drying are avoided.

The invention also relates, as novel products, to CNTs treated in this way and to their uses. The particularly preferred CNTs have an O/C atomic ratio, measured by ESCA, of equal to 5% or higher.

The CNTs treated according to the method described above may advantageously replace the untreated CNTs. They can be used in many fields, especially in electronics (depending on the temperature and their structure, they may be conductors, semiconductors or insulators), in mechanical applications, for example for the reinforcement of composites (CNTs are one hundred times stronger and six times lighter than steel) and in electromechanical applications (they can elongate or contract by charge injection). For example, mention may be made of the use of CNTs in macromolecular compositions intended for example for the packaging of electronic components, for the manufacture of fuel lines, antistatic coatings, in thermistors, electrodes for supercapacitors, etc.

### EXAMPLE 1

A carbon nanotube specimen was prepared by CVD from ethylene at 650° C. on an iron catalyst. The product resulting from the reaction contained an ash content measured by loss on ignition at 650° C. in air of 14% by weight, this specimen being called hereafter “CNT 1”.

A purification operation was carried out that consisted in subjecting 18.5 g of this product to 300 ml of a 14 wt % sulphuric acid solution for 8 h at 103° C. Once washed with water and dried, the resulting product had an ash content of 3.8% (including 1.3% iron and 1% aluminium). This specimen is called hereafter “CNT 1 SA”.

Surface functional groups on both specimens were measured using the Boehm method. This method, which is described in “Surface oxides of carbon”, H. P. Boehm, E. Diehl, W. Heck and R. Sappok, Angew. Chem. Internat., Vol. 3 (1964), No. 10, makes it possible, in a first approach, to estimate the surface functional groups according to their acid strength. These functional groups are listed below:
strong carboxylic acids=Group 1;
weak carboxylic acids=Group 2;
phenols=Group 3;
carbonyls=Group 4; and
basic functional groups=Group 5.

The results expressed in meq/g are given in Table 1 below:

TABLE 1

| | Group 1 | Group 2 | Group 3 | Group 4 | Group 5 |
|---|---|---|---|---|---|
| CNT 1 | 0.017 | 0 | 0.266 | 0 | 0.08 |
| CNT 1 SA | 0.1 | 0.027 | 0.39 | 0 | 0 |

It may therefore be seen that this type of treatment is slightly oxidizing and it increases the proportion of acid groups of the strong and weak carboxylic type, and also the phenol-type functional groups. The oxygen contents deduced from these measurements are, respectively, 0.48% and 1.03% by weight, corresponding to atomic ratios of 0.36% and 0.77%.

The ESCA measurements gave the following values, in atomic ratios:

| | C (%) | O (%) | Al (%) | Na (%) | O/C (%) |
|---|---|---|---|---|---|
| CNT 1 | 97.6 | 1.45 | 0.95 | <0.2 | 1.5 |
| CNT 1 SA | 98.9 | 1.1 | <0.3 | <0.2 | 1.1 |

This shows that the values given by ESCA are higher than those using the Boehm method.

It should also be pointed out that the acid treatment reduced the amount of aluminium, but, in contrast, the content of oxygen-containing functional groups measured by ESCA was not increased.

### EXAMPLE 2

18.5 g of CNT 1 were treated by means of 200 ml of a 2.2 wt % HNO₃ solution at 103° C. for 8 hours. The resulting product had an ash content of 3.9% (including 1.2% iron and 1.1% aluminium). The specimen will be called hereafter “CNT 1 NA”.

The measurements of the surface functional groups using the Boehm method are given in Table 2 below:

TABLE 2

| | Group 1 | Group 2 | Group 3 | Group 4 | Group 5 |
|---|---|---|---|---|---|
| CNT 1 | 0.017 | 0 | 0.266 | 0 | 0.08 |
| CNT 1 NA | 0.125 | 0 | 0.571 | 0 | 0 |

It may therefore be seen that this type of treatment is more oxidizing than that with H₂SO₄ and it greatly increases the phenol-type functional groups. The oxygen contents deduced from these measurements are, respectively, 0.48% and 1.3% by weight, corresponding to atomic ratios of 0.36% and 0.98%.

The ESCA measurements gave the following values:

| | C (%) | O (%) | Al (%) | Na (%) | O/C (%) |
|---|---|---|---|---|---|
| CNT 1 | 97.6 | 1.45 | 0.95 | <0.2 | 1.5 |
| CNT 1 NA | 97.6 | 2.4 | <0.3 | <0.2 | 2.46 |

Note the reduction in aluminium content caused by the acid treatment and the increase in oxygen-containing functional groups.

### EXAMPLE 3

20 g of nanotubes CNT 1 were added to 300 ml of 6.8% hydrogen peroxide. This was left with magnetic stirring for 4 hours at room temperature. Once filtered and dried, the resulting product was called “CNT 1 HP”. It was subjected to the same procedure for functional group measurements as in Example 1. The results using the Boehm method are given in Table 3 below:

TABLE 3

| | Group 1 | Group 2 | Group 3 | Group 4 | Group 5 |
|---|---|---|---|---|---|
| CNT 1 | 0.017 | 0 | 0.266 | 0 | 0.08 |
| CNT 1 HP | 0.189 | 0 | 0.221 | 0.410 | 0.044 |

It may therefore be seen that this type of treatment is also oxidizing and that it increases the proportion of acid groups of the strong carboxylic type and of carbonyl groups. The oxygen contents deduced from these measurements are, respectively, 0.48% and 0.96% by weight, corresponding to atomic ratios of 0.36% and 0.72%.

The ESCA measurements gave the following values:

| | C (%) | O (%) | Al (%) | Na (%) | O/C (%) |
|---|---|---|---|---|---|
| CNT 1 | 97.6 | 1.45 | 0.95 | <0.2 | 1.5 |
| CNT 1 HP | 96.5 | 2.4 | 1.1 | <0.2 | 2.4 |

This shows that the aluminium content has not decreased.

### EXAMPLE 4

100 ml of a 2 wt % aqueous sodium hypochlorite solution were prepared, to which 5 g of CNT 1 were added. After 4 hours with magnetic stirring at room temperature, the specimen was filtered, washed and dried. This specimen will be called hereafter “CNT 1 SH1”.

It was not possible to measure the surface functional groups by the Boehm method since the filtrations required by the Boehm method became very difficult.

Another specimen was prepared by oxidation in a 5 wt % aqueous sodium hypochlorite solution. In this case, a good portion of the product passed through a 0.2 μm Millipore filter. This means that the increase in concentration of the treatment caused a reduction in the hydrodynamic size of the nanotubes, probably by cutting them. This specimen will be called “CNT 1 SH2”.

The results of the surface functional group measurements by ESCA are the following:

| | C (%) | O (%) | Al (%) | Na (%) | O/C (%) |
|---|---|---|---|---|---|
| CNT 1 | 97.6 | 1.45 | 0.95 | <0.2 | 1.5 |
| CNT 1 SH1 | 91.1 | 7.5 | 0.9 | 0.5 | 8.2 |
| CNT 1 SH2 | 87.6 | 9.3 | 1.1 | 1.9 | 10.6 |

The aluminium content is not reduced. The table shows that the content of oxygen-containing functional groups is particularly high and that the treatment according to the invention is the most effective among those tested in liquid phase in Examples 1 to 3.

### EXAMPLE 5

A specimen was prepared by oxidizing 5 g of CNT 1 in 100 ml of a 5 wt % aqueous sodium hypochlorite solution for 4 hours at room temperature. Before filtration, the specimen was acidified to pH=3 using hydrochloric acid. It was found that, unlike the previous treatment, the nanotubes could be filtered and then washed, with only very few of the particles passing through the filter. This specimen is called “CNT 1 SH3”.

### EXAMPLE 6

The procedure for Example 4 (CNT 1 SH1) was repeated but the following variation was introduced: after the filtration and washing operations, the nanotubes were not dried but preserved, in a closed container, in the cake state having an approximately 11% solids content consisting of carbon nanotubes.

### EXAMPLE 7

The procedure for Example 4 (CNT 1 SH1) was repeated but, after the filtration and water-washing operations, the cake was washed with acetone without disassembling the filter. Once the cake had been washed with acetone, it was kept in a closed container without undergoing a drying operation.

### EXAMPLE 8

Another batch of carbon nanotubes purified with sulphuric acid (CNT 2 SA) was treated by means of a 95% air/5% O₃ mixture for 3 hours at room temperature.

The results of the surface functional group measurements by ESCA are given below:

| | C (%) | O (%) | H (%) | S (%) | O/C (%) |
|---|---|---|---|---|---|
| CNT 2 SA | 96.15 | 1.08 | 0.77 | 1.65 | 1.1 |
| CNT 2 SA-03 | 91.61 | 5.17 | 0.98 | <0.3 | 5.6 |

The ozone treatment has the advantage of not requiring a liquid phase. However, it is slightly less effective than the hypochlorite treatment for generating oxygen-containing functional groups. The treatment according to the invention is that which creates the maximum number of oxygen-containing functional groups. It generates only relatively benign waste.

### EXAMPLE 9

Dispersions were produced in water and in other solvents (acetone, methyl ethyl ketone (MEK) and toluene) by rapidly dispersing the nanotubes thus treated in a beaker after ultrasonification applied to the outside of the beaker. After 24 h, the state of the dispersion was observed and the results are given in the table below:

| | Water | Acetone | MEK | Toluene |
|---|---|---|---|---|
| CNT 1 | Sedimented | Sedimented | Sedimented | Surface |
| | | | | film |
| CNT 1 SA | Sedimented | | Sedimented | Surface |
| (Ex. 1) | | | | film |
| CNT 1 NA | Sedimented | | Sedimented | Surface |
| (Ex. 2) | | | | film |
| CNT 1 HP | Sedimented | | Sedimented | Surface |
| (Ex. 3) | | | | film |
| CNT 1 SH1 | Dispersed | Dispersed | Dispersed | Surface |
| (Ex. 4) | | | | film |
| CNT 1 SH3 | Dispersed | Dispersed | Dispersed | Surface |
| (Ex. 5) | | | | film |
| CNT 1 SH1 | Dispersed | Dispersed | Dispersed | Surface |
| (Ex. 6) | | | | film |
| CNT 1 SH1 | Dispersed | Dispersed | Dispersed | Surface |
| (Ex. 7) | | | | film |
| CNT 2 SA-O3 | Sedimented | Sedimented | Sedimented | |
| (Ex. 8) | | | | |

In view of the results of this table, it may be stated that the treatments according to the invention are the only ones that make it possible to disperse the carbon nanotubes formed using the CVD process described in polar solvents in a simple and stable manner.

1-4. (canceled)

5. A method of treating carbon nanotubes comprising:
a. contacting carbon nanotubes with a sodium hypochlorite solution having a concentration between about 0.5% and 15% by weight at a temperature not exceeding about 60° C. for a period of up to about 24 hours to form treated carbon nanotubes;
b. separating said treated carbon nanotubes via filtration; and thereafter
c. washing said treated carbon nanotubes.

6. The method of claim 5, wherein said sodium hypochlorite solution is an aqueous solution.

7. The method of claim 1, wherein said sodium hypochlorite solution concentration is between about 1% and 10% by weight.

8. The method of claim 1, further comprising the step of acidifying said treated carbon nanotubes to a pH lower than about pH5 with a mineral or organic acid prior to said separating.

9. The method of claim 1 wherein said washing is via water or a water and solvent mixture.

10. The method of claim 9 wherein said solvent is water miscible.

11. The method of claim 1, wherein said washing is followed by drying said treated carbon nanotubes.

12. The method of claim 1, wherein said treated carbon nanotubes have an oxygen to carbon atomic ratio of about 5% or higher.

13. A method of altering the mechanical and/or electrical properties of a polymeric composition comprising adding carbon nanotubes treated via the method of claim 1 to said polymeric composition.

14. Carbon nanotubes obtained via the method of claim 1.

15. The carbon nanotubes of claim 14 having an oxygen to carbon atomic ratio of about 5% or higher.
